(19) United States
(12) Patent Application Publication
(10) Pub. No.: US 2016/0004407 A1
(43) Pub. Date: Jan. 7, 2016

(54) MULTI-TOUCH SURFACE AUTHENTICATION USING AUTHENTICATION OBJECT

(71) Applicant: KONINKLIJKE PHILIPS N.V., Eindhoven (NL)

(72) Inventors: Robin Christiaan Antonius Brouns, Eindhoven (NL); Bartel Marinus Van De Sluis, Eindhoven (NL); Roel Peter Geert Cuppen, Venlo (NL)

(21) Appl. No.: 14/655,352

(22) PCT Filed: Jan. 24, 2014
(86) PCT No.: PCT/IB2014/058514

§ 371 Date: Jun. 25, 2015

Related U.S. Application Data
(60) Provisional application No. 61/758,896, filed on Jan. 31, 2013.

(51) Int. Cl. G06F 3/0488; G06K 9/00; G06F 21/31; G06F 3/045; H04L 29/06; G06F 3/041; G06F 3/044

(52) U.S. Cl. CPC G06F 3/0488; G06F 3/0412; G06K 9/00006; G06F 3/044; G06F 3/045; H04L 63/08; G06F 21/316; G06F 2203/04104; G06F 2203/04808

(57) ABSTRACT

The invention relates to a system (102) for user authentication, particularly suited for authentication of groups of users in hospital environments. The system (102) comprises an authentication object (104) provided with a redefined geometrical pattern (106) for authenticating the user. The system (102) furthermore comprises a multi-touch surface (108) provided with a primary layer (112) and a secondary layer (114). The multi-touch surface (108) is configured for generating in response to the pre-defined geometrical pattern (106) being brought into contact with the primary layer (112) a corresponding pattern of electric interaction between the primary and secondary layers thereby enabling unique authentication based on said pattern of electric interaction.

### TECHNICAL FIELD

The invention relates to a system for authentication.

### BACKGROUND ART

US 2009/0085877 A1 discloses a system for user authentication employing a multi-touch screen.

This system authenticates said user on the basis of multiple points of contact of his hand with the multi-touch screen since each hand has a unique contact pattern. However, it is virtually impossible for a user to exactly reproduce the unique contact pattern that provides for his or her authentication. Therefore the system is to employ relatively low standards concerning the accuracy with which said unique contact pattern needs be reproduced by the user; the system is to allow the user to reproduce its unique contact pattern with relatively large deviations. Consequently, for users with similar unique contract patterns, wrong authentication is likely to occur given the allowance of large deviations in reproducing their unique contact patterns. As a result a problem of this system is in its limited accuracy of authenticating.

### SUMMARY OF THE INVENTION

It is an object of the invention to provide a system for authentication capable of more accurately authenticating.

This object is obtained by the system according to the invention, which system comprises an authentication object provided with a predefined geometrical pattern for authenticating, and a multi-touch surface provided with a primary layer and a secondary layer, which multi-touch-surface is configured for generating in response to the predefined geometrical pattern being brought into contact with the primary layer a corresponding pattern of electric interaction between said primary and secondary layers, such that authentication is based on said pattern of electromagnetic induction.

By providing an authentication object having a predefined geometrical pattern, the system according to the invention enables accurately reproducing the pattern of electric interaction between the primary and secondary layers owing to the fact that the predefined geometrical pattern is a constant. Therefore the system is able to employ strict standards concerning the accuracy with which said pattern of electric interaction needs be reproduced in order to authenticate. In other words, the system enables to reproduce the predefined pattern of electric interaction with very small deviations only. More specifically, these deviations have an order of magnitude corresponding to the accuracy with which the predefined geometrical pattern is manufactured. The system thereby effectively prevents from erroneous authentication. As a result, the system of the invention increases the accuracy of authenticating.

The multi-touch surface may be planar yet may be geometrically curved alike.

In this text, electric interaction means mutually affecting culminating into an effect in the electrical domain, such as the flow of a current or the building up of a charge, including without limitation conductive coupling as well as capacitive coupling.

The system according to the invention advantageously allows, without limitation, for authentication of a person, in which the geometrical pattern is representative for said particular person. Hence, the system according to the invention is configured for authentication of a user. The system according to the invention furthermore advantageously enables authentication of a user group by providing members of such user group with authentication objects each provided with a predefined geometrical pattern that is specifically configured for that particular user group.

After authentication by the system according to the invention, a user or member of a user group may be provided with a mandate that is specifically adapted for said user or said specific user group to e.g. operate the hardware and/or software to which the system according to the invention may be connected.

The system according to the invention is particularly suited for application in hospital environments. By way of example and without limitation, the following user groups need authentication in order to operate a patient monitoring device to which the system according to the invention is connectable: (i) friends and/or relatives of patients, (ii) nurses, and (iii) doctors. Friends and/or relatives, after authentication, are to receive a mandate that merely allows for investigating a limited range of measurement data generated by the patient monitoring advice connected to the patient they are related to. Nurses, once authenticated, are to receive a mandate that allows for investigation of all measurement data. Doctors, after being authenticated, are to receive a mandate that allows not only for investigating all measurement data but also for changing the settings of the patient monitoring device.

The system according to the invention is advantageously capable of more accurately authenticating a person or a particular group of person without requiring for that purpose additional costly hardware such as badges and corresponding badge readers employing e.g. RFID technology.

The system according to invention equally advantageously enables authentication of a content item, such as a promotional coupon or a URL, in which the geometrical pattern is representative for said content item. Consequently the system according to the invention allows for successful application in web-based offerings of services or products to specific consumers. For such web-based offering, the authentication object may be part of a promotional object of any kind (e.g. card, label) handed out to consumers. Via such promotional object with predefined geometrical pattern customers can authenticate themselves and subsequently obtain access to specific parts of a website concerning the services or products. This application of the system circumvents the need for consumers to type complete URLs thereby facilitating and hence enhancing a sales process. The system according to the invention advantageously circumvents the need for a camera, e.g. a webcam, for such web-based offerings.

The predefined geometrical pattern may optionally comprise at least one protrusion, particularly a protrusion or set of protrusions that make the geometrical pattern a tactile pattern.

In a preferred embodiment of the system according to the invention, the multi-touch surface comprises a resistive multi-touch surface, and the predefined geometrical pattern comprises a protrusion configured for generating a corresponding pattern of conductive coupling between the primary and secondary layers in response to the predefined geometrical pattern being brought into contact with the primary layer. Owing to the characteristics of a resistive multi-touch surface, this embodiment does not require the authentication object to have particular resistivity or conductivity characteristics in order to generate the predefined pattern of conductive coupling. As a result this embodiment has the advantage of allowing for optimization of the authentication object in terms of e.g. ergonomics and usability.

In a further preferred embodiment of the system according to the invention, the system comprises a capacitive multi-touch surface, and the geometrical pattern comprises an element having a conductivity configured for generating a corresponding pattern of capacitive coupling between the primary and secondary layers in response to the predefined geometrical pattern being brought into contact with the primary layer. The element may be incorporated in the authentication object in an invisible manner. As a result the geometrical pattern is more difficult to retrieve and subsequently to falsify. Consequently this embodiment advantageously increases the security with which the system can perform authentication of the user.

In a further preferred embodiment of the system according to the invention, the authentication object is incorporated in an ID card. This embodiment merges the functionality of the authentication object with that of the ID card, which ID card often is already being carried by a person particularly in e.g. hospital environments. This embodiment therefore has the advantage of increasing usability of the system.

In a further preferred embodiment of the system according to the invention, the authentication object is incorporated in a primary mobile phone or a primary tablet. This embodiment merges the functionality of the authentication object with that of the primary mobile phone or primary tablet, which devices are already being carried by a person. This embodiment is therefore advantageous in that it increases usability of the system.

In a further preferred embodiment of the system according to the invention, the multi touch surface is incorporated in a secondary mobile phone or a secondary tablet, and said secondary mobile phone or secondary tablet is configured for transmitting a set of data to the primary mobile phone or primary tablet in response to the predefined geometrical pattern being brought into contact with the primary layer. This embodiment is advantageous in that it enables transmission of data, including but not limited to text documents, spreadsheets and digital business cards, in an effortless yet secured way.

In a further preferred embodiment of the system according to the invention, the secondary mobile phone (or smart phone) or secondary tablet is configured for transmitting a predefined set of data to the primary mobile phone (or smart phone) or primary tablet in response to the predefined geometrical pattern being brought into contact with a predefined location at the primary layer. This embodiment advantageously enables a user of the system to select in a very convenient way a particular set of data to be transmitted.

In a further preferred embodiment of the system according to the invention, the multi-touch surface comprises a multi-touch screen and the predefined location at the primary layer is identified by a computer icon at the multi-touch screen and representing the predefined set of data. This embodiment is advantageous in that it further facilitates the process of selecting the particular set of data to be transferred.

In a further preferred embodiment of the system according to the invention, the system is configured for authentication on the basis of a predefined displacement of the pattern of electric interaction in response to a displacement of the authentication object along the primary layer after the geometrical pattern being brought into contact with said primary layer. For the purpose of authenticating, this embodiment requires a user of the system not only to accurately reproduce the predefined pattern of electromagnetic induction; it moreover requires the user to generate a predefined displacement of said pattern. Provided the user of the system keeps such predefined displacement confidential, this embodiment effectively raises a barrier towards inaccurate authentication of a person, other than the user, having at his or hers disposal the authentication object. Therefore this embodiment advantageously increases the security of authentication.

### BRIEF DESCRIPTION OF DRAWINGS

FIG. 1A schematically displays a plan view of the system according to the invention.

FIG. 1B schematically depicts a cross-sectional view of the multi-touch surface according to the invention.

FIG. 2 schematically shows an embodiment in which the authentication object is incorporated in a primary mobile phone.

FIG. 3 schematically depicts an embodiment wherein the multi-touch surface is incorporated in a secondary mobile phone.

### DETAILED DESCRIPTION OF THE EMBODIMENTS

Touch screens are frequently found in smart phones and tablets. The majority of those touch screens are multi-touch enabled since this allows for a variety of powerful user interaction principles (zoom, scroll, rotate etc.). In view of this, an embodiment of the invention proposes to provide an object with a geometrical pattern (e.g. as a tactile pattern) that can act as an identifier when held against a multi-touch screen. The multi-touch screen interprets the pattern and translates it to an identifier that represents either a user, a particular user type (e.g. “role” such as patient, nurse) or a specific content piece.

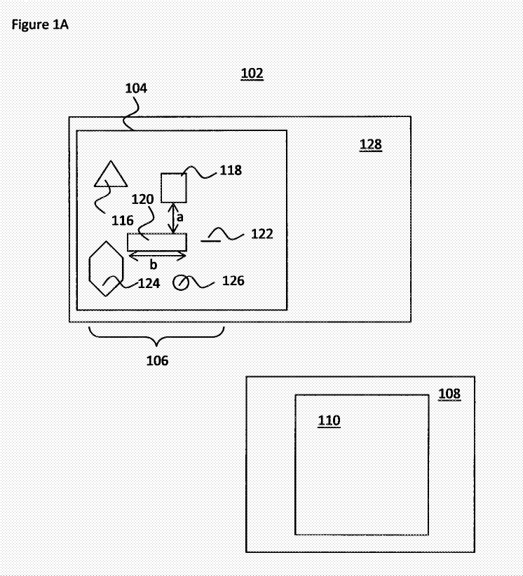

FIG. 1A schematically displays a system 102 for authentication, comprising an authentication object 104 provided with a predefined geometrical pattern 106 for authenticating. The system 102 furthermore comprises a multi-touch surface 108. Referring to FIG. 1B, said multi-touch surface 108 is provided with a primary layer 112 and a secondary layer 114. The multi-touch surface 108 is configured for generating a corresponding pattern of electric interaction between said primary and secondary layers in response to the predefined geometrical pattern 106 being brought into contact with the primary layer 112. The multi-touch surface 108 is configured for comparing, using methods and algorithms known per se, the corresponding pattern of electric interaction with reference patterns of electromagnetic induction, for example as stored in a database. Each of said reference patterns of electric interaction is uniquely linked to a respective user of the system 102 and hence performs as a user profile. The multi-touch surface 108 is provided with dimensions suitable for enabling the user to bring into contact the primary layer 112 and the geometrical pattern 106. More specifically, the multi-touch surface 108 has dimensions enabling the edge of the multi-touch surface 108 to envelop or encase the predefined geometrical pattern 106 when brought into contact with the primary later 112. The multi-touch surface 108 may comprise a multi-touch screen 110 known to the person skilled in the art.

In another example, referring to FIG. 1A, the geometrical pattern 106 comprises a plurality of geometrical figures i.e. a triangle 116, a square 118, a rectangle 120, a straight line 122, a hexagon 124 and a circle 126. The geometrical pattern 106 is furthermore defined by the distances between the various geometrical plane figures, e.g. distance a, as well as by the dimensions of the various geometrical plane curves, e.g. width b of rectangle 120. Other geometrical figures, such as ellipses and pentagons, are suitable as well for the geometrical pattern 106. Furthermore, the geometrical pattern 106 may comprise a dot or a plurality of dots arranged in a predefined manner on the authentication object 104. Alternatively, the geometrical pattern may comprise a single geometrical figure preferably having a high geometrical complexity such as a fractal structure. The multi-touch surface 108 may comprise a multi-touch screen 110 known to the person skilled in the art. In this specific example, the multi-touch screen 110 overlaps with the primary layer 112 and the secondary layer 114 in full. Alternatively, the multi-touch screen 110 may overlap partially with the primary layer 112 and the secondary layer 114.

In another example, the multi-touch surface 108 comprises a resistive multi-touch surface. Without limitation the resistive multi-touch surface may comprise a resistive multi-touch screen. Furthermore, the geometrical pattern 106 comprises protrusions 116, 118, 120, 122, 124 and 126 for generating a corresponding pattern of conductive coupling between the primary layer 112 and the secondary layer 114 in response to the predefined geometrical pattern 106 being brought into contact with the primary layer 112. In this specific example the primary layer 112 and the secondary layer 114 are mutually separated by a gap. The primary layer 112 is provided with a relatively small mechanical stiffness compared to e.g. the secondary layer 114, at least with respect to bending deformation. More specifically said relatively small mechanical stiffness is arranged for enabling that the primary layer 112 will contact the secondary layer 114, in a pattern corresponding to the predefined geometrical pattern 106, once the predefined geometrical pattern 106 has been brought into contact with the primary layer 112. The protrusions 116, 118, 120, 122, 124 and 126, being unique for a user, together constitute a tactile profile on a side of authentication object 104. For example and without limitation, the protrusions 116, 118, 120, 122, 124 and 126 may be provided with a height in the range of 0.2 mm to 2 mm relative to the authentication object 104. The geometrical pattern 106 may furthermore be defined by the thicknesses of the protrusions 116, 118, 120, 122, 124 and 126. For example and without limitation, the protrusions 116, 118, 120, 122, 124 and 126 may be provided with thicknesses in the range of 0.1 mm to 1 mm. Alternatively, the protrusions 116, 118, 120, 122, 124 and 126 may be embodied by solids. Furthermore, the geometrical pattern may comprise a solid protrusion (or a plurality thereof) and a non-solid protrusion (or a plurality thereof).

In a further example, the multi-touch surface 108 comprises a capacitive multi-touch surface. Without limitation the capacitive multi-touch surface may comprise a capacitive multi-touch screen. Furthermore, the geometrical pattern 106 comprises elements 116, 118, 120, 122, 124 and 126 all having a conductivity or having a range of conductivities configured for generating a corresponding pattern of capacitive coupling between the primary layer 112 and the secondary layer 114 in response to the predefined geometrical pattern 106 being brought into contact with the primary layer 112. The elements 116, 118, 120, 122, 124 and 126 may be realized by pads of conductive materials known to the person skilled in the art.

In another example, the authentication object 104 is incorporated in an ID card 128 known per se. In one possible embodiment, such a card may contain a tactile profile on one of its sides. This tactile profile causes the card to have a number of unique pressure points that contact the multi-touch screen. The order and alignment of these points give the card its unique ID. The multi-touch screen is able to keep track of multiple points that can be compared with a database of possible profiles and their corresponding users. Parameters used to generate a unique ID may for example comprise distances between points, relative location to each other, and possible shape of a point.

The profile points on an authentication object such as an ID-card can for example be small thickened locations on this object (e.g. in case of a resistive touch screen), or invisible conductive pads grounded via the user (e.g. in case of a capacitive touch screen). A higher number of points on the object allows for more complex profiles, but requires the touch screen to be able to read the equal amount of points at the same time.

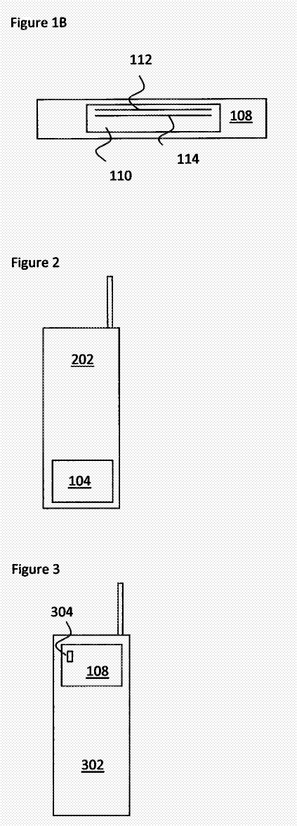

In a further example, referring to FIG. 2, the authentication object 104 is incorporated in a primary mobile phone 202. Alternatively, the authentication object 104 may be incorporated in a tablet.

In a particular example, referring to FIG. 3, the multi-touch surface 108 is incorporated in a secondary mobile phone 302. Alternatively, the multi-touch surface 108 may be incorporated in a tablet. In either case, the multi-touch surface 108 may comprise a multi-touch screen.

In another example, in which the multi touch surface 108 is incorporated in the secondary mobile phone 302, the secondary mobile phone 302 is configured for transmitting a set of data to the primary mobile phone 202 in response to the predefined geometrical pattern 106 being brought into contact with a predefined location at the primary layer 112.

In a specific example in which the multi-touch surface 108 comprises a multi-touch screen, the predefined location at the multi-touch surface (108) is identified by a computer icon (304), e.g. a short-cut, at the multi-touch screen and representing the predefined set of data.

In a particular example the system 102 is configured for authentication of the user on the basis of a corresponding displacement of the pattern of electric interaction in response to a displacement of the authentication object 104 along the primary layer 112, after the geometrical pattern 106 is brought into contact with said primary layer, and using methods and algorithms known per se. In this specific example the multi-touch surface 108 is configured for comparing, using methods and algorithms known per se, the corresponding displacement of the pattern of electric interaction with reference displacements of patterns of electromagnetic induction, for example as stored in a database. Each of said reference displacements of patterns of electric interaction is uniquely linked to a respective user of the system 102 and hence performs as a user profile.

While the invention has been illustrated and described in detail in the drawings and in the foregoing description, the illustrations and the description are to be considered illustrative or exemplary and not restrictive. Other combinations of embodiments are feasible. It is noted that the system according to the invention and all its components can be made by applying processes and materials known per se. In the set of claims and the description the word “comprising” does not exclude other elements and the indefinite article “a” or “an” does not exclude a plurality. Any reference signs in the claims should not be construed as limiting the scope. It is further noted that all possible combinations of features as defined in the set of claims are part of the invention.

1. A system for authentication, comprising:
an authentication object provided with a predefined geometrical pattern for authenticating, and
a multi-touch surface provided with a primary layer and a secondary layer, which multi-touch surface is configured for generating in response to the predefined geometrical pattern being brought into contact with the primary layer a corresponding pattern of electric interaction between said primary and secondary layers, such that authentication based on said pattern of electric interaction.

2. The system according to claim 1, wherein the multi-touch surface comprises a resistive multi-touch surface, and wherein the predefined geometrical pattern comprises a protrusion configured for generating a corresponding pattern of conductive coupling between the primary and secondary layers in response to the predefined geometrical pattern being brought into contact with the primary layer.

3. The system according to claim 1, wherein the multi-touch surface comprises a capacitive multi-touch surface, and wherein the geometrical pattern comprises an element having a conductivity configured for generating a corresponding pattern of capacitive coupling between the primary and secondary layers in response to the predefined geometrical pattern being brought into contact with the primary layer.

4. The system according to claim 1 wherein the authentication object is incorporated in an ID card.

5. The system according to claim 1, wherein the authentication object is incorporated in a primary mobile phone.

6. The system according to claim 5, wherein the multi touch surface is incorporated in a secondary mobile phone, and wherein the secondary mobile phone is configured for transmitting a set of data to the primary mobile phone in response to the predefined geometrical pattern being brought into contact with the primary layer.

7. The system according to claim 6, wherein the secondary mobile phone is configured for transmitting a predefined set of data to the primary mobile phone in response to the predefined geometrical pattern being brought into contact with a predefined location at the primary layer.

8. The system according to claim 7, wherein the multi touch surface comprises a multi-touch screen and wherein the predefined location at the primary layer is identified via a computer icon at the multi-touch screen and representing the predefined set of data.

9. The system according to claim 1, wherein the system is configured for authentication on the basis of a predefined displacement of the pattern of electric interaction in response to a displacement of the authentication object along the primary layer after the geometrical pattern being brought into contact with said primary layer.

10. The system according to claim 1, wherein the predefined geometrical pattern is shaped by a primary plane curve selected from the group of triangles, rectangles, circles, squares, ellipses, pentagons and hexagons.
